(19) United States
(12) Patent Application Publication
(10) Pub. No.: US 2011/0291398 A1
(43) Pub. Date: Dec. 1, 2011

(54) Funeral planning heirloom

(76) Inventor: Tara Lea Reynolds, Littleton, CO (US)

(21) Appl. No.: 12/802,060

(22) Filed: May 28, 2010

(51) Int. Cl. B42D 1/00

(52) U.S. Cl. 281/31

(57) ABSTRACT

A method for pre-planning a funeral comprising a memorial book with special features to summarize thoughts, wishes, memories, and plans after one's death is herein disclosed. The memorial book allows a person to plan for their funeral services while also serving to preserve a person's memory through their own thoughts, remembrances and memorabilia. The memorial book comprises a plurality of pockets binder and multiple sections that contain personal and important information. With all such information gathered in a single place, it relieves the next of kin from having to make difficult decisions that have already been made by the deceased.

### RELATED APPLICATIONS

The present invention was first described in a notarized Official Record of Invention on Jul. 14, 2008; that is on file at the offices of Montgomery Patent and Design, LLC. There are no previously filed, nor currently any co-pending applications, anywhere in the world.

### I. FIELD OF THE INVENTION

The present invention relates generally to a funeral planning heirloom and, more specifically, to said heirloom which provides means for an individual to create a memorial having special features which summarize thoughts, wishes, memories, and plans after one's death.

### II. MOTIVATION FOR THE INVENTION

The reality of death is something we all must face. While a will is commonly used to determine the distribution of one's assets after death, there are many other facets of life that one may wish to pass on. Such particular wishes include funeral arrangements, burial locations, and even the music to be played or scripture passages to be read during the funeral. Others may look to pass along letters, flowers, or even specific memories to specific people. A person may want photographs that have special meaning to be passed on to specific people. Others may wish to pass along legal information such as asset location, banking information, or life insurance policies. Unfortunately, there is not a single specific location to look for all of this information, and the next of kin can often spend much time trying to assemble this material at a very difficult time in their lives. Accordingly, there exists a need for a means by which information to be organized and distributed after one's death can be safely and centrally located in a manner with great taste and sentimental significance. The development of the present invention fulfills this need.

The invention comprises a memory book having special features which may summarize thoughts, wishes, memories, and plans after one's death. Initial observation of the invention bears similar features to standard scrapbooks, photo albums, or the like, yet comprises additional features such as, a plurality of discs, a plurality of notepads, a notebook, and a plurality of pockets. The invention further comprises a tri-fold, multi-sectional binder designed to be a tool to assist in the process of preplanning a funeral and persevering the individual's memories and thoughts. One (1) side of the invention contains pockets for holding the CD's or DVD's which contain songs or videos one would like to be played at their funeral. A second section comprises multiple removable notebooks which are specifically dedicated for use with a particular heir. It would contain special notes, memories or thoughts about that specific person. Previous received letters or photographs could also be included. A third section would contain important information about funeral arrangements, burial wishes, life insurance policies, banking account information, assets, and the like. With all such information gathered in one place, it relieves the next of kin from having to make difficult decisions that have already been made by the deceased. The use of the invention provides peace of mind for those close to death and those who will be left behind in a manner which provides comfort immediately after death but for years to come as well.

### III. DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a front view of a funeral planning heirloom 10 depicting a front cover portion, according to a preferred embodiment of the present invention; and,

FIG. 2 is a deployed view of the funeral planning heirloom 10, according to a preferred embodiment of the present invention.

### DESCRIPTIVE KEY

10 funeral planning heirloom
15 photograph
20 cover
22 cover pocket
24 indicia
30 first section
32 compact disc
34 compact disc pocket
40 second section
42 notepad
44 notepad pocket
50 third section
52 notebook
54 notebook pocket
56 vacant pocket
58 fastening means
60 label

### IV. DESCRIPTION OF THE INVENTION

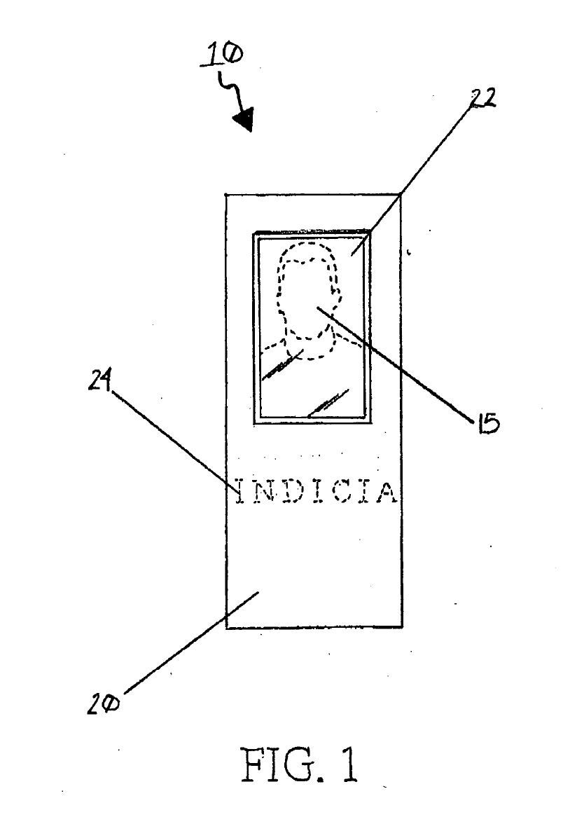

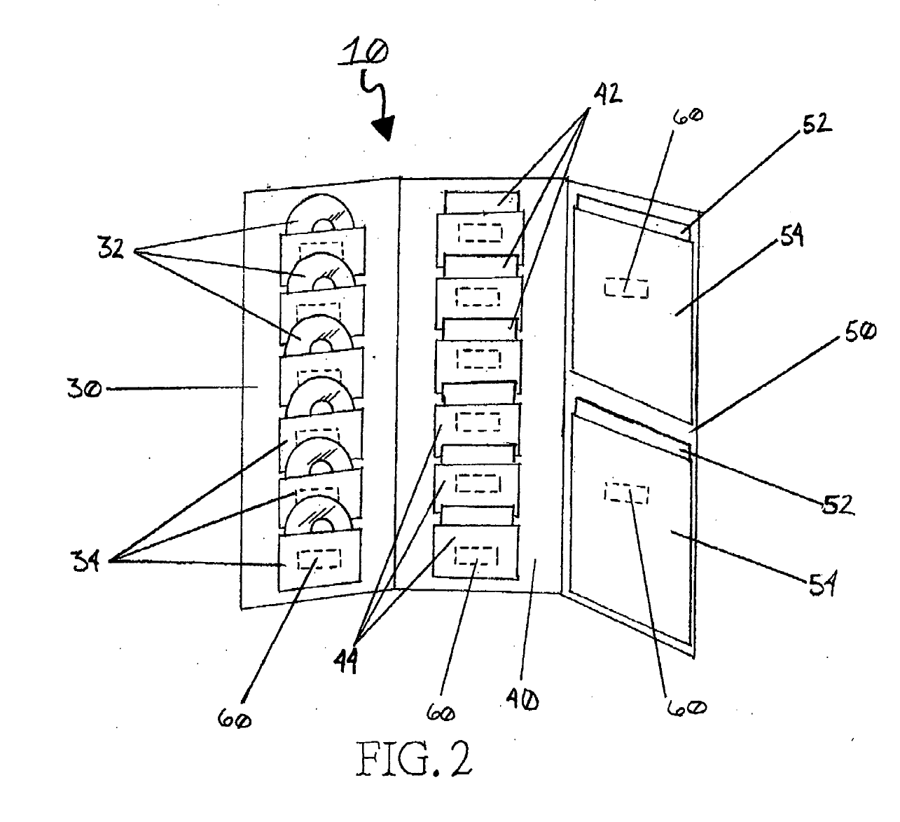

The best mode for carrying out the invention is presented in terms of its preferred embodiment, herein depicted within FIGS. 1 and 2.

### 1. Detailed Description of the Figures

The present invention describes a device and method for a funeral planning heirloom (herein described as the “apparatus”) 10, which provides a means for an individual thereto create a memorial book with special features to summarize thoughts, wishes, memories, and plans after one's death. Initial observation of the apparatus 10 bears similar features to standard scrapbooks, photo albums, or the like, yet comprising features such as, but not limited to: a plurality of compact discs 32, a plurality of notepads 42, a notebook 52, and a plurality of pockets 34, 44, 54, 56. The apparatus 10 is a tri-fold, multi-sectional binder designed to be a tool thereto assist in the process of preplanning a funeral and persevering the individual's memories and thoughts. The apparatus 10 would be fabricated using well-known processes such as printing, die stamping, extrusion, heat welding and the like.

Referring now to FIG. 1, a front view of the apparatus 10, according to the preferred embodiment of the present invention, is disclosed. The apparatus 10 comprises a cover 20, thereby providing a decorative protective binding means. The cover 20 comprises a cover pocket 22, thereby providing a transparent rectangular protective pouch thereto insert and display photographs 15 or images of the individual for whom the apparatus 10 is created. The cover 20 also comprises a space utilized for a variety of indicia 24 which may provide script or logos based upon the individual's preference and may include images such as, but not limited to: messages, personal names, pictures, symbols, and the like to further customize and personalize the apparatus 10. The cover 20 is envisioned to be approximately eleven-and-a-half (11½) inches in height and approximately seven (7) inches wide. It is also envisioned for the cover 20 to be secured to a closed fashion therewith devices such as, but not limited to: a ribbon, a buckle, a magnetic strip, or the like.

Referring now to FIG. 2, a deployed view of the apparatus 10, according to the preferred embodiment of the present invention, is disclosed. The apparatus 10 comprises three (3) sections, thereby providing storage and organization means for personal and sentimental articles. The individual sections of the apparatus 10 are envisioned thereto be printed on heavy archival grade paper. When the apparatus 10 is deployed, in an open and flat manner, it is envisioned thereto be approximately twenty-four (24) inches wide. The first section 30 comprises up to and including six (6) compact discs 32 and corresponding rectangular compact disc pockets 34. The compact discs 32 are envisioned to be uploaded therewith digital data such as, but not limited to: videos, pictures, songs, or the like. The compact disc 32 and compact disc pockets 34 would best be obtained from wholesalers and manufacturers that deal in goods of that nature.

The second section 40 comprises up to and including six (6) removable notepads 42 and corresponding rectangular notepad pockets 44. The notepads 42 are envisioned to be specifically dedicated for use with a particular heir and contain special notes, memories, or thoughts about that specific person. Pictures, letters, and other sentimental messages may also be included. The notepads 42 are secured therewithin the corresponding notepad pockets 44 and are also obtained from wholesalers and manufacturers that deal in goods of that nature.

The third section 50 comprises a notebook 52 and corresponding rectangular notebook pocket 54. The notebook 52 is envisioned to be used for additional information about final wishes, assets, burial arrangements, or the like that are to be incorporated thereinto the individual's funeral.

The third section also comprises a vacant pocket 56 which further comprises a fastening means 58. The vacant pocket 56 is envisioned to hold documents such as, but not limited to: life insurance policies will information, and the like and the fastening means 58 enables said vacant pocket 56 to be secured in a closed position. The fastening means 58 is depicted as being a common zipper for illustration purposes only, it is known that other fastening devices may be incorporated such as, but not limited to: tongue-and-groove fasteners, hook-and-loop fasteners, buttons, adhesives, or the like. Said fastening means 58 may also be incorporated thereon the abovementioned pockets 34, 44, 54 without limiting the functions of the apparatus 10.

It is envisioned that all pockets 34, 44, 54, 56 incorporate a label 60, thereby providing a text portion thereto describe the contents. The label 60 portions are envisioned to be comprised of devices such as, but not limited to: adhesive backed tags, transparent plastic sleeves for the insertion of cards, a paper region for hand writing, or the like.

It is also envisioned that an upper distal portion of each section 30, 40, 50 may incorporate an internal sleeve, thereby providing an additional pocketed sleeve portion to each section 30, 40, 50. The sleeves provide a protection and storage means to additional larger documents which require careful handling such as, legal documents, large photographs, or the like. The sleeves may incorporate a fastening means such as, but not limited to: a zipper, adhesives, or the like, thereby providing protection to its contents. It is understood that the apparatus 10 may be introduced having any individual section 30, 40, 50 or combination of said sections 30, 40, 50 comprising the internal sleeve portion and as such should not be viewed as a limiting factor of said apparatus 10.

It is envisioned that other styles and configurations of the present invention can be easily incorporated into the teachings of the present invention, and only one particular configuration shall be shown and described for purposes of clarity and disclosure and not by way of limitation of scope.

### 2. Operation of the Preferred Embodiment

The preferred embodiment of the present invention can be utilized by the common user in a simple and effortless manner with little or no training. After initial purchase or acquisition of the apparatus 10, it would be installed as indicated in FIGS. 1 and 2.

The method of utilizing the apparatus 10 may be achieved by performing the following steps: acquiring the apparatus 10; placing a photo 15 or message therein the cover pocket 22; unfolding the cover 20 thereto deploy the apparatus 10; removing a necessary amount of compact discs 32 therefrom the compact disc pockets 34 thereon the first section 30; adding songs, movies, and/or video messages thereto the compact discs 32; replacing the compact disc 32 thereinto the compact disc pockets 34 when finished; removing notepads 42 therefrom the notepad pocket 44 thereon the second section 40 and writing important or sentimental information; replacing the notepads 42 thereinto the notepad pockets 44 when finished; removing the notebook 52 therefrom the notebook pocket 54 thereon the third section 50; writing comments and replacing the notebooks 52 thereinto the notebook pockets 54 when finished; placing personal documents thereinto the vacant pocket 56 and securing in a closed position with the fastening means 58; folding the apparatus 10 thereinto its original position therewith the cover 20 visible; and, benefitting from the information and images contained in the present invention during a time of bereavement or remembrance.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is understood that various omissions or substitutions of equivalents are contemplated as circumstances may suggest or render expedient, but is intended to cover the application or implementation without departing from the spirit or scope of the claims of the present invention.

What is claimed is:

1. A funeral planning heirloom.

2. The heirloom of claim 1, further comprising a cover, a plurality of sections, a plurality of pockets, and labeling indicia.

3. A method of utilizing a funeral planning heirloom comprising a cover, a plurality of sections, a plurality of pockets, and labeling indicia.
